(19) United States
(12) Patent Application Publication
(10) Pub. No.: US 2026/0109873 A1
(43) Pub. Date: Apr. 23, 2026

(54) HIGH SOLID CONTENT AQUEOUS WHITE PIGMENT PASTE

(71) Applicant: Everlight Chemical Industrial Corporation, Taipei City (TW)

(72) Inventors: Ta-Ming LIU, Taoyuan City (TW); Wei-Chi WU, Taoyuan City (TW); Hsiao-San CHEN, Taoyuan City (TW)

(21) Appl. No.: 19/326,824

(22) Filed: Sep. 12, 2025

(30) Foreign Application Priority Data
Oct. 18, 2024 (TW) 113139794

(51) Int. Cl. C09D 17/00; C09D 11/037; C09D 11/107; C09D 11/322; C09D 11/38

(52) U.S. Cl. CPC C09D 17/008; C09D 11/037; C09D 11/107; C09D 11/322; C09D 11/38; C09D 17/001

(57) ABSTRACT

A high solid content aqueous white pigment paste includes: TiO₂ powders; an anionic polyelectrolyte; a charge regulator; an pH regulator; and water. Herein, based on a total weight of the aqueous white pigment paste, the content of the TiO₂ powders is 65 to 80 wt %, and a weight ratio of the TiO₂ powders to the anionic polyelectrolyte ranges from 130 to 180.

### CROSS-REFERENCE TO RELATED APPLICATIONS

This application claims the benefits of the Taiwan Patent Application Serial Number 113139794, filed on Oct. 18, 2024, the subject matter of which is incorporated herein by reference.

### BACKGROUND OF THE INVENTION

### Field

The present invention relates to a high solid content aqueous white pigment paste. More specifically, the present invention relates to a high solid content aqueous white pigment paste used for inkjet printing inks.

### Description of Related Art

When carrying out white or color printing on dark or light-colored substrate, white pigment paste is usually used. In addition to forming white prints, the use of white pigment paste can also enhance the color sharpness of the formed color prints.

There are white pigment pastes available on the market for preparing inkjet printing inks. For example, modified TiO₂ powders or undried TiO₂ powders are used as pigments for white pigment pastes. However, most of the aqueous white pigment pastes currently available on the market suffer from sedimentation, resulting in poor re-dispersibility or storage stability, which limits their application range.

In view of this, it is desirable to develop an aqueous white pigment paste that can improve the above-mentioned shortcomings to meet the application requirements of inkjet printing inks.

### SUMMARY OF THE INVENTION

One object of the present invention is to provide a high solid content aqueous white pigment paste with good re-dispersibility or storage stability.

The high solid content aqueous white pigment paste of the present invention comprises: TiO₂ powders; an anionic polyelectrolyte; a charge regulator; an pH regulator; and water, wherein a content of the TiO₂ powders is 65 to 80 wt % based on a total weight of the aqueous white pigment paste, and a weight ratio of the TiO₂ powders to the anionic polyelectrolyte ranges from 130 to 180.

In the high solid content aqueous white pigment paste of the present invention, the re-dispersibility or storage stability of the aqueous white pigment paste can be improved by using an anionic polyelectrolyte. More specifically, the sedimentation problem of TiO₂ powders (pigment) can be improved by adding a small amount of anionic polyelectrolyte. Even the solid content of the TiO₂ powders (pigment) is high and the weight ratio of the TiO₂ powders to the anionic polyelectrolyte is greater (TiO₂ powders/anionic polyelectrolyte, P/D), the sedimentation problem of TiO₂ powders (pigment) still can be effectively improved to provide an aqueous white pigment paste with good re-dispersibility or storage stability.

In one embodiment, the weight ratio of the TiO₂ powders to the anionic polyelectrolyte (TiO₂ powders/anionic polyelectrolyte, P/D) may range from 130 to 180, for example, from 135 to 180, from 135 to 175, from 140 to 175, from 140 to 170, from 145 to 170 or from 145 to 165.

In one embodiment, based on the total weight of the aqueous white pigment paste, the content of the TiO₂ powders may be 65 to 80 wt %, and for example, may be 65 to 75 wt %.

In one embodiment, based on the total weight of the aqueous white pigment paste, the content of the anionic polyelectrolyte may be 0.3 to 0.7 wt %, and for example, may be 0.3 to 0.65 wt %, 0.35 to 0.65 wt %, 0.35 to 0.6 wt %, 0.4 to 0.6 wt % or 0.4 to 0.55 wt %.

In one embodiment, based on the total weight of the aqueous white pigment paste, the content of the charge regulator may be 0.25 to 0.6 wt %, and for example, may be 0.25 to 0.55 wt %, 0.3 to 0.55 wt %, 0.3 to 0.5 wt %, 0.35 to 0.5 wt % or 0.4 to 0.5 wt %.

In one embodiment, based on the total weight of the aqueous white pigment paste, the content of the pH regulator may be 0.1 to 0.4 wt %, and for example, may be 0.1 to 0.3 wt %, 0.15 to 0.3 wt %, 0.15 to 0.25 wt % or 0.2 to 0.25 wt %.

In one embodiment, the TiO₂ powders are surface-modified TiO₂ powders. In one embodiment, the TiO₂ powders are TiO₂ powders modified with alumina.

In one embodiment, the anionic polyelectrolyte may be an anionic polyelectrolyte comprising phosphate, carboxylate or sulfonate. In one embodiment, the anionic polyelectrolyte may be polyacrylic acid (PAA), polystyrene sulfonate (PSS), polyacrylamide sulfonate (PAMPS), carboxymethyl cellulose (CMC), sulfonated phenolic resin (SPR), polyvinyl sulfonic acid (PVSA), a salt thereof (such as lithium, sodium, potassium or ammonium salts), or a combination thereof. In one embodiment, the anionic polyelectrolyte may be sodium polyacrylate (PAAS).

In one embodiment, the molecular weight of the anionic polyelectrolyte may be 1000 to 15000 g/mol, and for example, may be 1200 to 15000 g/mol or 1200 to 8000 g/mol.

In one embodiment, the charge regulator may be aluminum oxide hydroxide (AlO(OH)).

In one embodiment, the pH regulator may be sodium metasilicate (Na₂SiO₃).

In addition, the high solid content aqueous white pigment paste of the present invention is prepared by grinding a mixture comprising the TiO₂ powders, the anionic polyelectrolyte, the charge regulator, the pH regulator and water. Herein, the grinding process may be a media grinding process, a horizontal grinding process, or a high-speed dispersion process, and the aforementioned grinding processes may be used alone or in combination of two or more grinding processes.

Furthermore, the high solid content aqueous white pigment paste of the present invention may comprise at least one of the following properties: the surface tension of the aqueous white pigment paste is greater than 60 mN/m, and for example, greater than 65 mN/m, wherein the surface tension of the aqueous white pigment paste is measured by diluting the aqueous white pigment paste to a solid content of 10 wt %;
the iso-electric point (IEP) of the aqueous white pigment paste is pH 2.3 to pH 3.2, and for example, pH 2.4 to pH 3.1; and the absolute value of the zeta potential of the aqueous white pigment paste is greater than or equal to 30 mV (|±30 mV|) when the aqueous white pigment paste has pH greater than 4.5 (for example, greater than 4.5 and less than 13).

In addition, the high solid content aqueous white pigment paste of the present invention can be used for inkjet printing.

Other novel features of the disclosure will become more apparent from the following detailed description when taken in conjunction with the accompanying drawings.

### BRIEF DESCRIPTION OF DRAWINGS

FIG. 1 is a diagram showing the iso-electric point measurement results of Examples 1 to 3 and Comparative Examples 1 to 2 of the present invention.

FIG. 2 is a diagram showing the iso-electric point measurement results of Examples 4 to 6 and Comparative Examples 1 to 2 of the present invention.

### DETAILED DESCRIPTION OF THE INVENTION

The following describes the implementation of the present invention through specific examples. Those skilled in the art can easily understand other advantages and effects of the present invention from the content disclosed in this specification. The present invention can also be implemented or applied through other different specific embodiments. Various details in the present specification can also be modified and changed in various ways according to different viewpoints and applications without departing from the spirit of the present invention.

Unless otherwise specified herein, the feature A “or” or “and/or” the feature B refers to the presence of the feature A alone, the feature B alone, or both the feature A and the feature B. The feature A “and” the feature B means that the feature A and the feature B exist at the same time. The terms “include”, “comprise”, “have” and “contain” mean including but not limited to these.

If a value is between a first value and a second value, the value may be the first value, the second value, or another value between the first value and the second value.

Moreover, in the present specification, “about” a numerical value refers to the scope including ±10% of the numerical value, particularly the scope of ±5% of the numerical value. The quantity given here is an approximate quantity, that is, in the absence of a specific description “about”, the meaning of “about” can still be implied.

The present invention will be described in more detail by way of examples, but these examples are not intended to limit the scope of the present invention. Unless otherwise specified, in the following comparative examples and examples, temperatures are in degrees Celsius, and parts and percentages are by weight. The relationship between parts by weight and parts by volume is similar to the relationship between kilograms and liters.

The ingredients used in the following examples and comparative examples of the present invention are shown in Table 1 below.

TABLE 1
Ingredient

Surface-modified TiO₂ (TIOXIDE ® RFDO)
Charge regulator
Aluminum oxide hydroxide (AlO(OH))
pH regulator
Sodium metasilicate (Na₂SiO₃)
Anionic polyelectrolyte
Sodium polyacrylate (PAAS)

### Comparative Example 1

60.0 wt % of TiO₂ pigment powders were dissolved in 40.0 wt % of pure water using a mechanical stiffer (NETZSCH MasterMix). Then, the mixture was ground in a bead mill (SUNIN MACHINE CO., LTD. GOLDEN-MILL) using yttrium zirconium grinding beads having a diameter of 0.3 to 0.4 mm to obtain the aqueous white pigment paste of Comparative Example 1.

### Comparative Example 2

60.0 wt % of TiO₂ pigment powders were dissolved in a premix of 0.18 wt % of sodium metasilicate, 0.37 wt % of aluminum oxide hydroxide and pure water as the remainder, and uniformly mixed using a mechanical stiffer (NETZSCH MasterMix). Then, the mixture was ground in a bead mill (SUNIN MACHINE CO., LTD. GOLDEN-MILL) using yttrium zirconium grinding beads having a diameter of 0.3 to 0.4 mm to obtain the aqueous white pigment paste of Comparative Example 2.

### Example 1

65.0 wt % of TiO₂ pigment powders were dissolved in a premix of 0.20 wt % of sodium metasilicate, 0.40 wt % of aluminum oxide hydroxide, 0.44 wt % of sodium polyacrylate and pure water as the remainder, and uniformly mixed using a mechanical stirrer (NETZSCH MasterMix). Then, the mixture was ground in a bead mill (SUNIN MACHINE CO., LTD. GOLDEN-MILL) using yttrium zirconium grinding beads having a diameter of 0.3 to 0.4 mm to obtain the aqueous white pigment paste of Example 1.

### Examples 2 to 6

According to the ingredient contents listed in Tables 2 and 3 below, the aqueous white pigment pastes of Examples 2 to 6 were prepared using the preparation method described in Example 1.

### Zeta Potential Measurement

The ground aqueous white pigment paste of the example and comparative examples was formulated into dispersion solutions of 10 ppm. The pH value of the dispersion solution was adjusted to 2 to 12, and 8 to 10 pH points were selected. Zeta potential was measured using MALVERN ZETASIZER NANO ZS and plotted to obtain the isoelectric point (IEP). The results are shown in Tables 2 and 3 below.

### Surface Tension

The ground aqueous white pigment pastes of the examples and comparative examples were diluted with water to a solid content of 10 wt %. The surface tension was measured using a KYOWA SURFACE TENSIOMETER CBVP-A2. The results are shown in Tables 2 and 3 below.

TABLE 2
(unit: wt %)

| | Comparative | Comparative | | | |
|---|---|---|---|---|---|
| | example 1 | example 2 | Example 1 | Example 2 | Example 3 |
| TiO₂ | 60% | 60% | 65% | 70% | 75% |
| Na₂SiO₃ | — | 0.18% | 0.20% | 0.21% | 0.23% |
| AlO(OH) | — | 0.37% | 0.40% | 0.43% | 0.46% |
| PAAS | — | — | 0.44% | 0.48% | 0.51% |
| Water | Add to 100% | | | | |
| IEP | 9.1 | 7.8 | 3.0 | 3.0 | 3.0 |
| pH value with zeta | Less | Less | Greater | Greater | Greater |
| potential >\|±30 mV\| | than 6.8 | than 5.3 | than 4.8 | than 4.9 | than 5.1 |
| (Stabilized range) | Greater | Greater | | | |
| | than 10.3 | than 9.1 | | | |
| Surface tension after | 71.7 | 70.4 | 72.3 | 71.8 | 68.2 |
| dilution (mN/m) | | | | | |

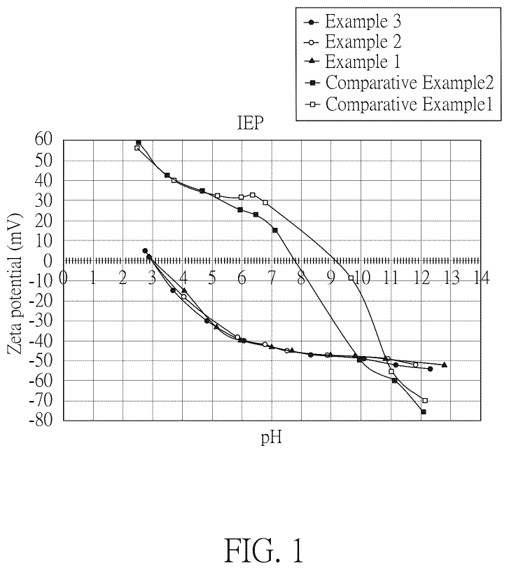

Please refer to the results of Table 2 above and FIG. 1. To meet the pH range of 7 to 9 for white ink applications, Comparative Example 1 used a commercially available surface-modified TiO₂ aqueous solution (iso-electric point 9.1, pH stabilized range less than 6.8 or greater than 10.3) for the charge property adjustment. When the charge regulator (aluminum oxide hydroxide) and the pH regulator (sodium metasilicate) were added, as shown in Comparative Example 2, the IEP was lowered from 9.1 to 7.8, but the pH value for stable suspension still did not fall within the application range of the ink. When the anionic polyelectrolyte (sodium polyacrylate, PAAS) was added, as shown in Examples 1 to 3, the IEP was significantly reduced to 3. In addition, as shown in FIG. 1, when the pH value is greater than 4.5, the aqueous white pigment pastes of Examples 1 to 3 have high and stable suspension stability. Regardless of whether the solid content exceeds 65% (Example 1) or 70% (Example 2), or even when the solid content is increased to 75% (Example 3), the TiO₂ particles in the aqueous white pigment paste of the present invention still maintain high suspension stability and do not delaminate or settle.

Furthermore, the aqueous white pigment paste of the present invention has excellent surface tension properties. As the surface tension of the aqueous white pigment paste increases (for example, the surface tension of the aqueous white pigment paste of the present invention may be greater than 60 mN/m, and even greater than 70 mN/m), the selectivity of the dispersant (e.g., the dispersant used in ink formulation) becomes more diverse, which helps to improve the splattering problem caused by large differences in surface tension between different substrates when using aqueous white pigment paste.

TABLE 3
(unit: wt %)

| | Comparative | Comparative | | | |
|---|---|---|---|---|---|
| | example 1 | example 2 | Example 4 | Example 5 | Example 6 |
| TiO₂ | 60% | 60% | 70% | 70% | 70% |
| Na₂SiO₃ | — | 0.18% | 0.21% | 0.21% | 0.21% |
| AlO(OH) | — | 0.37% | 0.43% | 0.43% | 0.43% |
| Molecular weight of | — | — | 1200 | 8000 | 15000 |
| PAAS (0.48%) | | | | | |
| Water | Add to 100% | | | | |
| IEP | 9.1 | 7.8 | 3.1 | 2.7 | 2.4 |
| pH value with zeta | Less | Less | Greater | Greater | Greater |
| potential >\|±30 mV\| | than 6.8 | than 5.3 | than 4.5 | than 5.3 | than 6.2 |
| (Stabilized range) | Greater | Greater | | | |
| | than 10.3 | than 9.1 | | | |
| Surface tension after | 71.7 | 70.4 | 71.5 | 71.8 | 70.4 |
| dilution (mN/m) | | | | | |

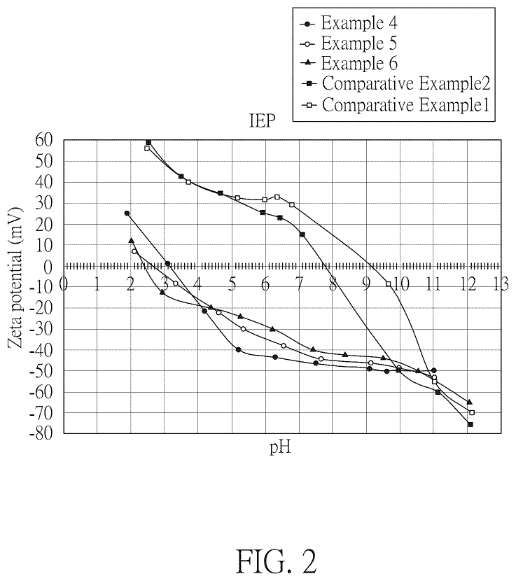

The results in Table 3 above and FIG. 2 verify the effect of the molecular weight of the anionic polyelectrolyte on dispersion stability. In the examples, PAAS with a molecular weight of 1200 (Example 4), 8000 (Example 5), and 15000 (Example 6) were used to adjust the zeta potential/IEP of TiO₂ particles. The results showed that the anionic polyelectrolytes with the aforementioned molecular weights could make IEP to 3.1, 2.7, and 2.4, respectively. However, as the molecular weight of the anionic polyelectrolyte increased, the pH at which the zeta potential fell below −30 mV shifted from 4.5 to 5.3 or even above 6.2. That is to say, when PAAS with a molecular weight of 15,000 is added, the pH needs to be above 6.2 to achieve better suspension stability. The above results show that as the molecular weight of the anionic polyelectrolyte increases, the pH value for achieving better suspension stability also increases. Therefore, when the molecular weight for better suspension stability is within a specific range, good suspension stability can be achieved.

In view above, the high solid content aqueous white pigment paste provided by the present invention can maintain a good stability (the absolute value of the zeta potential can be greater than or equal to 30 mV (|ζ|≥30 mV)) even when the solid content of the TiO₂ powders exceeds 65 wt %. Thus, the applicability of the aqueous white pigment paste can be significantly improved. On the other hand, the high solid content aqueous white pigment paste provided by the present invention has an iso-electric point (IEP) of approximately pH 3, and can reach an absolute value of the zeta potential greater than or equal to 30 mV (|ζ|≥30 mV) at a pH greater than 4.5. Thus, the pH range of the aqueous white pigment paste can be significantly expanded. Furthermore, the high solid content aqueous white pigment paste provided by the present invention has a high surface tension (>60 mN/m). Thus, the surface tension adjustment capabilities of the aqueous white pigment paste can be significantly improved.

The above embodiments are merely examples for the convenience of description. The scope of rights claimed by the present disclosure should be based on the scope of the patent application, and is not limited to the above embodiments.

Although the present disclosure has been explained in relation to its embodiment, it is to be understood that many other possible modifications and variations can be made without departing from the spirit and scope of the disclosure as hereinafter claimed.

1. A high solid content aqueous white pigment paste, comprising:
TiO₂ powders;
an anionic polyelectrolyte;
a charge regulator;
an pH regulator; and
water,
wherein a content of the TiO₂ powders is 65 to 80 wt % based on a total weight of the aqueous white pigment paste, and a weight ratio of the TiO₂ powders to the anionic polyelectrolyte ranges from 130 to 180.

2. The aqueous white pigment paste of claim 1, wherein a content of the anionic polyelectrolyte is 0.3 to 0.7 wt %, a content of the charge regulator is 0.25 to 0.6 wt %, and a content of the pH regulator is 0.1 to 0.4 wt %.

3. The aqueous white pigment paste of claim 1, wherein the anionic polyelectrolyte is an anionic polyelectrolyte comprising phosphate, carboxylate or sulfonate.

4. The aqueous white pigment paste of claim 1, wherein the anionic polyelectrolyte is polyacrylic acid, polystyrene sulfonate, polyacrylamide sulfonate, carboxymethyl cellulose, sulfonated phenolic resin, polyvinyl sulfonic acid, a salt thereof, or a combination thereof.

5. The aqueous white pigment paste of claim 1, wherein the anionic polyelectrolyte is sodium polyacrylate.

6. The aqueous white pigment paste of claim 1, wherein a molecular weight of the anionic polyelectrolyte is 1000 to 15000 g/mol.

7. The aqueous white pigment paste of claim 1, wherein the charge regulator is aluminum oxide hydroxide.

8. The aqueous white pigment paste of claim 1, wherein the pH regulator is sodium metasilicate.

9. The aqueous white pigment paste of claim 1, wherein a surface tension of the aqueous white pigment paste is greater than 60 mN/m.

10. The aqueous white pigment paste of claim 1, wherein an iso-electric point of the aqueous white pigment paste is pH 2.3 to pH 3.2.

11. The aqueous white pigment paste of claim 1, wherein an absolute value of a zeta potential of the aqueous white pigment paste is greater than or equal to 30 mV when the aqueous white pigment paste has pH greater than 4.5.
